(19) United States
(12) Patent Application Publication
(10) Pub. No.: US 2015/0169503 A1
(43) Pub. Date: Jun. 18, 2015

(54) E-READER DEVICE AND SYSTEM FOR ALTERING AN E-BOOK USING CAPTURED CONTENT ITEMS

(71) Applicant: Kobo Inc., Toronto (CA)

(72) Inventor: Nathan Maharaj, Toronto (CA)

(73) Assignee: Kobo Inc., Toronto (CA)

(21) Appl. No.: 14/133,038

(22) Filed: Dec. 18, 2013

(51) Int. Cl. G06F 17/21; G06F 3/0484

(52) U.S. Cl. CPC G06F 17/212; G06F 3/04842

(57) ABSTRACT

A processor operates to capture one or more content items that are provided through operation of an input mechanism, and to associate the one or more content items with an e-book. The processor can identify a publisher's indicia for displaying a representation of the e-book. The process alters publisher's indicia to include content corresponding to the one or more content items, and further stores the altered publisher's indicia in the memory. A representation of the e-book is displayed, based on the altered publisher's indicia. The representation can be made selectable or interactive in order to access a content portion of the e-book.

### TECHNICAL FIELD

Examples described herein provide for an e-reader device and system for altering an e-book using captured content items.

### BACKGROUND

An electronic personal display is a mobile electronic device that displays information to a user. While an electronic personal display is generally capable of many of the functions of a personal computer, a user can typically interact directly with an electronic personal display without the use of a keyboard that is separate from or coupled to but distinct from the electronic personal display itself. Some examples of electronic personal displays include mobile digital devices/tablet computers such (e.g., Apple iPad®, Microsoft® Surface™, Samsung Galaxy Tab® and the like), handheld multimedia smartphones (e.g., Apple iPhone®, Samsung Galaxy S®, and the like), and handheld electronic readers (e.g., Amazon Kindle®, Barnes and Noble Nook®, Kobo Aura HD, and the like).

An electronic reader, also known as an e-reader device, is an electronic personal display that is used for reading electronic books (e-books), electronic magazines, and other digital content. For example, digital content of an e-book is displayed as alphanumeric characters and/or graphic images on a display of an e-reader such that a user may read the digital content much in the same way as reading the analog content of a printed page in a paper-based book. An e-reader device provides a convenient format to store, transport, and view a large collection of digital content that would otherwise potentially take up a large volume of space in traditional paper format.

In some instances, e-reader devices are purpose-built devices designed to perform especially well at displaying readable content. For example, a purpose built e-reader device includes a display that reduces glare, performs well in highly lit conditions, and/or mimics the look of text on actual paper. While such purpose built e-reader devices excel at displaying content for a user to read, they can also perform other functions, such as displaying images, emitting audio, recording audio, and web surfing, among others.

There also exist numerous kinds of consumer devices that can receive services and resources from a network service. Such devices can operate applications or provide other functionality that links the device to a particular account of a specific service. For example, e-reader devices typically link to an online bookstore, and media playback devices often include applications which enable the user to access an online media library. In this context, the user accounts can enable the user to receive the full benefit and functionality of the device.

### BRIEF DESCRIPTION OF THE DRAWINGS

FIG. 1 illustrates a system for providing e-book services, according to an embodiment.

FIG. 2 illustrates an example of an e-reader device or other electronic personal display device, for use with one or more embodiments described herein.

FIG. 3 illustrates an e-reader system for organizing book titles, according to one or more embodiments.

FIG. 4 illustrates a method for capturing and integrating content items with an e-book, according to one or more environment.

FIG. 5 illustrates a method for acquiring an e-book based on the obtained signature or image of an author, according to one the more embodiments.

FIG. 6 illustrates a content capture interface for use with an e-reader device, according to one or more embodiments.

FIG. 7A illustrates a content screen that is provided on the e-reader device when the device is in an off-state.

FIG. 7B illustrates a library view of an e-book collection in which at least one e-book includes a modified book cover image.

### DETAILED DESCRIPTION

According to examples provided herein, an e-reader device can be operated to alter aspects of an e-book with captured content items. In particular, a manner in which an e-book is represented on a computing device can be altered based on captured content items, such as provided with an image or digital ink input.

Among other benefits, examples enable a user to personalize an e-book with digital ink input and images, so that the manner in which the e-book is represented (e.g., displayed in a virtual library) reflects the personalization. By way of example, a user can acquire an author's autograph and/or picture, and further have the autograph or picture integrated with a book cover image that is used to represent the e-book with the user's device or account.

In one embodiment, a computing device includes a memory, one or more input mechanisms, a display, and a processor. The processor operates to capture one or more content items that are provided through operation of the input mechanism, and to associate the one or more content items with an e-book. The processor also identifies a publisher's indicia for displaying a representation of the e-book. The process afters publisher's indicia to include content corresponding to the one or more content items, and further stores the altered publisher's indicia in the memory. A representation of the e-book is provided on the display, based on the altered publisher's indicia. The representation can be made selectable or interactive in order to access a content portion of the e-book.

One or more embodiments described herein provide that methods, techniques and actions performed by a computing device are performed programmatically, or as a computer-implemented method. Programmatically means through the use of code, or computer-executable instructions. A programmatically performed step may or may not be automatic.

One or more embodiments described herein may be implemented using programmatic modules or components. A programmatic module or component may include a program, a subroutine, a portion of a program, or a software or a hardware component capable of performing one or more stated tasks or functions. As used herein, a module or component can exist on a hardware component independently of other modules or components. Alternatively, a module or component can be a shared element or process of other modules, programs or machines.

Furthermore, one or more embodiments described herein may be implemented through instructions that are executable by one or more processors. These instructions may be carried on a computer-readable medium. Machines shown or described with figures below provide examples of processing resources and computer-readable mediums on which instructions for implementing embodiments of the invention can be carried and/or executed. In particular, the numerous machines shown with embodiments of the invention include processor(s) and various forms of memory for holding data and instructions. Examples of computer-readable mediums include permanent memory storage devices, such as hard drives on personal computers or servers. Other examples of computer storage mediums include portable storage units, such as CD or DVD units, flash or solid state memory (such as carried on many cell phones and consumer electronic devices) and magnetic memory. Computers, terminals, network enabled devices (e.g., mobile devices such as cell phones) are all examples of machines and devices that utilize processors, memory, and instructions stored on computer-readable mediums. Additionally, embodiments may be implemented in the form of computer programs, or a computer usable carrier medium capable of carrying such a program.

System Description

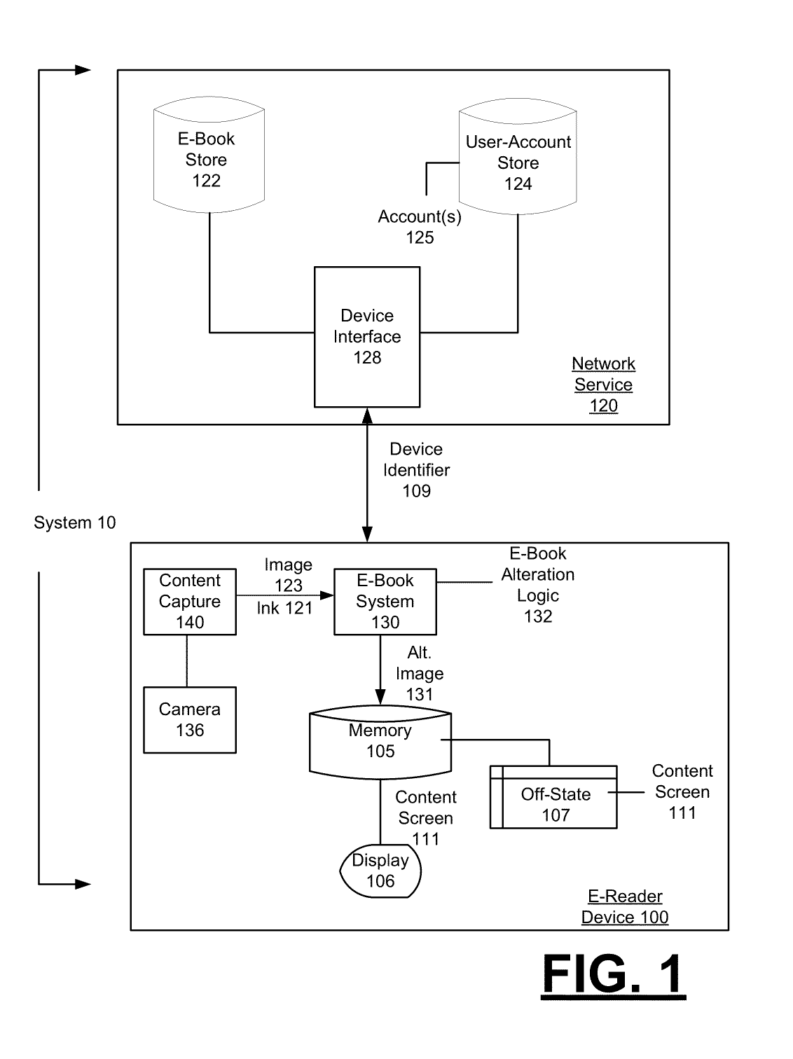

FIG. 1 illustrates a system for providing e-book services, according to an embodiment. In an example of FIG. 1, system 10 includes an electronic display device, shown by way of example as an e-reader device 100, and a network service 120. The network service 120 can include multiple servers and other computing resources that provide various services in connection with one or more applications that are installed on the e-reader device 100. By way of example, in one implementation, the network service 120 can provide e-book services which communicate with the e-reader device 100. The e-book services provided through network service 120 can, for example, include services in which e-books are sold, shared, downloaded and/or stored. More generally, the network service 120 can provide various other content services, including content rendering services (e.g., streaming media) or other network-application environments or services.

The e-reader device 100 can correspond to any electronic personal display device on which applications and application resources (e.g., e-books, media files, documents) can be rendered and consumed. For example, the e-reader device 100 can correspond to a tablet or a telephony/messaging device (e.g., smart phone). In one implementation, for example, e-reader device 100 can run an e-reader application that links the device to the network service 120 and enables e-books provided through the service to be viewed and consumed. In another implementation, the e-reader device 100 can run a media playback or streaming application that receives files or streaming data from the network service 120. By way of example, the e-reader device 100 can be equipped with hardware and software to optimize certain application activities, such as reading electronic content (e.g., e-books). For example, the e-reader device 100 can have a tablet-like form factor, although variations are possible.

In additional detail, the network service 120 can include a device interface 128, an e-book store 122 and a user account store 124. The user account store 124 can associate the e-reader device 100 with a user and with an account 125. The e-book store 122 can provide book titles that the user can acquire right of possession for. For example, the user can operate the e-reader device 100 to purchase and download e-books from e-book store 122. As an alternative or addition, the e-reader device 100 can access the e-book store 122 to download e-books on a temporal basis, such as to borrow or rent. The account 125 can also be associated with one or more application resources (e.g., e-books), which can be stored in the e-book store 122. As described further, the user account store 124 can retain metadata for individual accounts 125 to identify resources that have been purchased or made available for consumption for a given account. The e-reader device 100 may be associated with the user account 125, and multiple devices may be associated with the same account. As described in greater detail below, the e-reader device 100 can store resources (e.g., e-books) that are purchased or otherwise made available to the user of the e-reader device 100 through the e-book store 122, as well as to archive e-books and other digital content items that have been purchased for the user account 125, but are not stored on the particular computing device.

The e-reader device 100 includes features for providing and enhancing functionality related to displaying paginated content, and more specifically, to rendering e-books and providing e-book services. In an embodiment, the e-reader device 100 includes an e-book system 130 which communicates with the network service 120 and provides various kinds of e-book related functionality. The e-book system 130 can communicate a device identifier 109 to the network service 120 so that the network service links the e-reader device 100 to an account 125 of the user. The e-book system 130 can include, for example, an application that accesses the network service 120 over the Internet. Among other functions, the e-book system 130 can display e-books and other content provided from the network service 120.

In more detail, the e-reader device 100 can include an e-book system 130, a memory 105, and a display assembly 106. The e-book system 130 can include functionality for enabling various kinds of reading and e-book activities, including enabling a user to (i) read an e-book, (ii) provide input such as page transitions, (iii) purchase e-books for the e-book store 122 of the network service 120, and (iv) organize an e-book library on the e-reader device 100.

According to some embodiments, content capture logic 140 includes programming to capture content items through one or more input interfaces of the e-reader device 100. In particular, the content capture logic 140 can capture digital ink input 121, which can be drawn by a person on, for example, a touch sensitive display screen or surface of the e-reader device 100. By way of example, digital ink input 121 can correspond to an autograph or signature, or a phrase. In specific examples, the digital ink input 121 can correspond to an autograph and accompanying message from an author of an e-book. In variations, the digital ink input 121 can be captured using pointer devices, or through image inserts communicated to the e-reader device. More generally, some implementations provide for content capture logic 140 to capture ink input, such as phrases or other input. The ink input can be entered by, for example, a person that interacts with an input mechanism of the device by providing a gesture (e.g., drawn finger across display screen), or other free-form movement. As an addition or alternative, the content capture logic 140 can also capture an image 123, which can be provided through, for example, a camera 136 of the e-reader device 100. As an addition or variation, the content capture logic 140 can select content items such as images from the memory 105, or from another source (e.g., a network source etc.).

According to some embodiments, the e-book system 130 can include functionality for embedding content items provided through the content capture logic 140. In particular, the e-book system 130 can include e-book alteration logic 132 for embedding captured content items in a manner that afters a portion of an e-book. More specifically, some embodiments provide that the content items received through content capture logic 140 are embedded, or otherwise integrated into a publisher's indicia of an e-book. The publisher's indicia can correspond to, or otherwise include, an image, such as an image representation of a book or jacket cover (“book cover image”). In one aspect, the image representation can be provided in iconic form.

In one aspect, the e-book system 130 can store altered aspects of the selected e-book. The altered aspects can be based on the content items received through the content capture logic 140. In some embodiments, the e-book system 130 replaces or otherwise afters the publisher's indicia to include the content items (e.g., ink input 121, image 123). As shown with an example of FIG. 1, the altered publisher's indicia can correspond to, or include an altered cover image 131. In such examples, aspects such as the book cover or jacket cover are then altered for the particular e-book based on the content items received through the content capture component 140.

In some embodiments, the display assembly 106 is an electronic paper type. Among characteristics of electronic paper type displays, the e-reader device 100 can display content even when the device is in an off-state. In particular, static content can be displayed on the e-reader device 100 while the device is in the off-state. The memory 105 of the e-reader device 100 can include an off-state component 107 or portion where a content screen for an actively in use e-book is stored. The off-state memory 107 can be a dedicated memory resource and/or implemented through programming. The content screen 111 can be generated at least in part from a selected e-book that is in active use (e.g., unread, recently accessed and being viewed). In one implementation, the content screen 111 can display information and images corresponding to a cover image of an e-book. In an example of FIG. 1, the content screen 111 can include the content items (ink input 121, image 123) received through the content capture logic 140. In one embodiment, the content screen 111 can correspond or include the altered cover image 131.

In some variations, the e-reader device 100 displays the content screen when the e-book system 130 (or the e-reader device 100) is in an inactive state (rather than an off-sate). By way of example, the e-reader device 100 can display the content screen 111 on an LCD type display to simulate, for example, a wall paper or provide a screen-saver.

Hardware Description

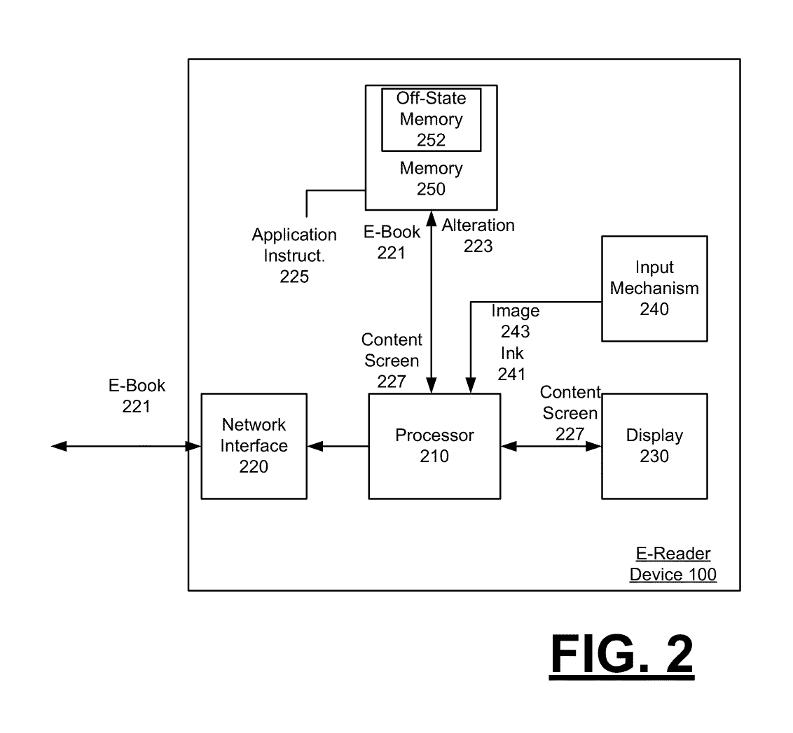

FIG. 2 illustrates an example of an e-reader device or other electronic personal display device, for use with one or more embodiments described herein. In an example of FIG. 2, an e-reader device 100 can correspond to, for example, a device, such as also shown by an example of FIG. 1. With reference to FIG. 2, e-reader device 100 includes a processor 210, a network interface 220, a display assembly 230, one or more input mechanisms 240, and memory resources 250.

The processor 210 can implement functionality using instructions stored in the memory resources 250. Additionally, in some implementations, the processor 210 utilizes the network interface 220 to communicate with the network service 120 (see FIG. 1). More specifically, the e-reader device 100 can access the network service 120 to receive various kinds of resources 221 (e.g., digital content items such as e-books, configuration files, account information), as well as to provide information (e.g., user account information, service requests etc.). For example, e-reader device 100 can receive application resources 221, such as e-books or media files, that the user elects to purchase or otherwise download from the network service 120. The application resources 221 that are downloaded onto the e-reader device 100 can be stored in the memory resources 250.

As an addition or alternative, resources 221 that are received on the e-reader device 100 can include information about book titles. The information can include, for example, a publisher's indicia (e.g., book cover or illustration for an e-book) of an e-book for the book title. For example, the publisher's indicia about book titles can be provided in the context of recommended book titles for the user.

In some implementations, the display assembly 230 can correspond to, for example, a liquid crystal display (LCD) or light emitting diode (LED) display that illuminates in order to provide content generated from processor 210. In some implementations, the display assembly 230 can be touch-sensitive. In some variations, the display assembly 230 can correspond to an electronic paper type display, which mimics conventional paper in the manner in which content is displayed. Examples of such display technologies include electrophoretic displays, electrowetting displays, and electrofluidic displays.

The processor 210 can receive input from various sources, including the input mechanisms 240, the display assembly 230 or other input mechanisms (e.g., buttons, keyboard, microphone, etc.). With reference to examples described herein, the processor 210 can generate output on the display assembly 230 to prompt the user for a response (e.g., selection input), and further respond to input provided by the user through a selected input mechanism 240.

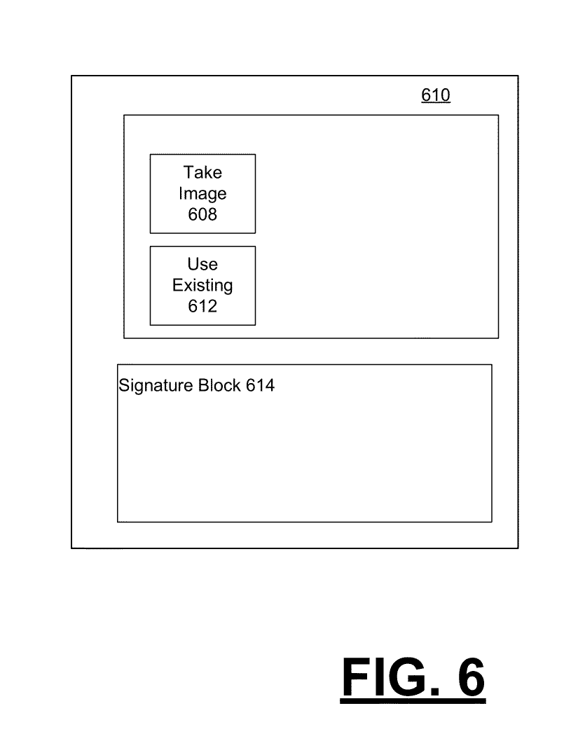

In one embodiment, memory resources 250 include instructions 225 for providing content capture logic 120 (see FIG. 1) and other aspects of e-book system 130, including e-book alteration logic 132. The processor 210 can execute instructions 225 to generate an interface for receiving at least one of an ink input 241 (e.g., signature or autograph, phrase etc.) or image 243. In particular, inputs corresponding to ink input 241 or image 243 can be provided through use of one of the input mechanisms 240, and in response to an interface provided by the processor 210 implementing the instructions 225. The interface can correspond to, for example, a touchscreen prompt to enable a person to enter a hand-drawn or free-form movement that represents the ink input (e.g., autograph or signature). The interface can alternatively prompt or enable a user to take an image, or to select one from a particular location. An example of an interface is shown with FIG. 6.

In one embodiment, the processor 210 can provide the interface in the context of a particular e-book. For example, the interface can be operated to select a particular e-book, or triggered from use of a particular e-book. When provided, the processor 210 can perform operations that correspond to the e-book alteration logic 132. The input (ink input 241 and/or image 243) can be integrated with a portion of the e-book, such as the cover page or other publisher indicia. Once integrated, an alteration 223 (e.g., altered book cover image) can be stored in the memory resources 250. In some examples, the alteration 223 is permanently provided as part of the corresponding e-book. In this way, the alteration 223 can substitute as the representation of the e-book on the device. Accordingly, under one aspect, the processor 210 displays the alteration 223 when the corresponding e-book is being represented in a particular operating environment, such as part of the library, or prior to the user viewing the contents of the e-book.

Still further, in some variations, the display assembly 230 includes an off-state mode that can display a content screen 227. For example, memory resources 250 can include off-state component 252 that stores the content screen 227 for display when the e-reader device 100 is in the off-state. In one implementation, the content screen 227 can be based on a publisher's indicia for a given e-book, such as the book cover image of an e-book that a user is currently reading. In one implementation, the content screen 227 can be based on, or otherwise include the altered book cover image as the alteration 223. For example, the user can capture the autograph of an author for a particular e-book, then read the e-book and have the cover page of the e-book altered on the e-reader device 100 (and optionally with the user's account 125) to show the autograph of the author. The cover page of the e-book can be displayed in the user's library, in altered form so that the autograph can be indicated or otherwise visible. Additionally, in variations, the off-state of the display assembly 230 can provide content screen 227 that includes the cover page of the e-book (e.g., when the e-book is being read), as modified with the autograph.

Still further, the processor 210 can receive content items corresponding to ink input 241 and/or image 243. The processor 210 can implement operations to identify a search criterion that corresponds to the inputs. For example, the processor 210 can implement a recognition process on the ink input 241 and/or image 243 in order to identify an author from the inputs. The processor 210 can further determine whether a corresponding or relevant e-book is locally stored with memory resources 250 or associated with the user account 125 (see FIG. 1, e.g., archived e-book). If an e-book from the author is not locally stored on the device, the processor 210 can access a network service using the network interface 220. The processor 210 can further provide the user with a prompt that enables an option for the user to purchase one or more e-books corresponding to the particular author.

E-Reader System

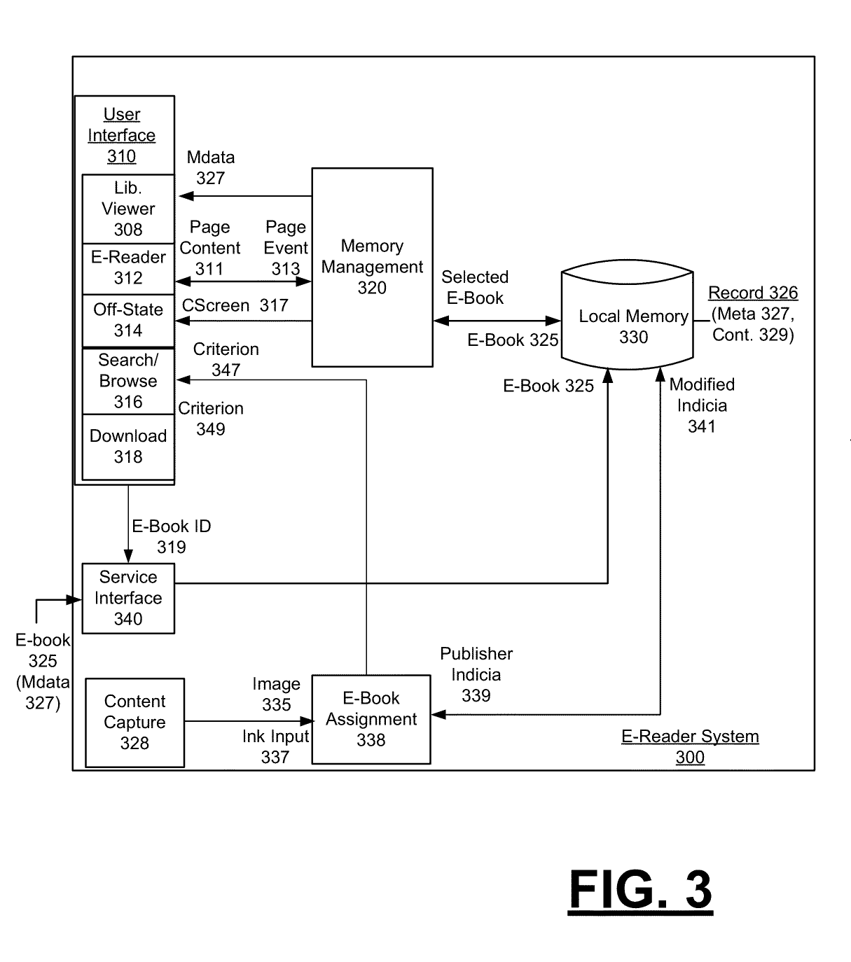

FIG. 3 illustrates an e-reader system for organizing book titles, according to one or more embodiments. An e-reader system 300 can be implemented as for example, an application or device, using components that execute on, for example, an e-reader device 100 such as shown with examples of FIG. 1, or FIG. 2. Furthermore, an e-reader system 300 such as described can be implemented in a context such as shown by FIG. 1 and FIG. 2. In reference to FIG. 3, an e-reader system 300 can implement programmatic components for communicating with an e-book service (such as network service 120, shown in FIG. 1), as well as for enabling organization of e-books utilized by an account associated with the e-reader device 100. In some implementations, the e-reader system 300 can be implemented as an application that runs on the e-reader device 100 (e.g., such as shown by FIG. 1 or FIG. 2).

In an example of FIG. 3, the e-reader system 300 includes a user interface 310, a memory management module 320, a local memory 330, and a service interface 340. The programmatic components shown with the e-reader system 300 can be provided as part of an application that runs on the e-reader system 300. For example, the user can download an application onto a mobile computing device in order to obtain functionality such as described herein, as well as to communicate with a network service 120. Alternatively, the application can be embedded or otherwise preinstalled with other programmatic elements for providing such functionality on a computing device.

The service interface 340 includes application and logic which enables the device to use, for example, a wireless Internet connection, to connect to the network service 120 (see FIG. 1). In connecting with the service, the service interface 340 can transmit data that enables the network service 120 to identify e-reader system 300 (or alternatively the user) so that the network service 120 can determine the account associated with the e-reader device 100. The service interface 340 can be used to retrieve e-books 325 from the network service 120. For example, in identifying the e-reader system 300 with the network service 120, the network service may be able to procure payment information (e.g., stored credit card) that can be used to charge a user's account when the user purchases a new e-book. Each e-book can correspond to a literary work, having pagination, chapter designations and optionally graphics and formatting. Individual e-books 325 can also include metadata 327, including the publisher's indicia (e.g., cover image provided in iconic form), that provide imagery for marketing the e-book similar to the manner in which a conventional hardbound book would be marketed in a retail store. In one implementation, the network service 120 can retrieve or otherwise identify the metadata 327 of individual e-books from publisher sources.

In identifying the e-reader system 300, the network service 120 can identify what e-books belong to the account of that device. E-books that are transmitted to the e-reader system 300 include those that are purchased from the e-reader device 100, or those that the user requested to download. The user can be deemed to have a right of possession to an e-book version of a book title when the user rightfully downloads or acquires the right to download an e-book.

In variations, e-books can automatically be downloaded to the device in response to the occurrence of certain conditions. For example, the user can purchase an e-book on another device, and then subsequently connect to the network service 120 via the e-reader system 300 to automatically receive the previously purchased e-book. Alternatively, network service 120 can be configured to push e-books to the e-reader system 300, based on, for example, user account settings, subscription rules, and various other business logic consideration.

According to some embodiments, the local memory 330 stores each e-book 325 as a record 326 that includes metadata 327 (e.g., publisher's indicia, cover image) and content 329 (e.g., page content). The local memory 330 can retain the record 326 of each e-book that the user has downloaded, or can download (e.g., archived e-book). In one implementation, the record 326 includes the publisher's indicia, which can be in the form of a book cover image, as well as other metadata that is used to represent the e-book as an entry in one of the lists. The record 326 can also link to the content of the e-book 325. The content of the e-book 325 can be stored locally (e.g., with local memory resource 330) or remotely (e.g., with the user account 125 on the network service 120).

As an addition or alternative, the memory 330 can be used to store records 326 corresponding to e-books that are in the possession of the user, but not local on the device. By way of example, the memory 330 can include records 326 for e-books that are archived or stored remotely on the device (e.g., with the user store 124 on the network service 120 in FIG. 1).

With further reference to FIG. 3, the user interface 310 includes a library viewer 308, an e-reader 312, an off-state component 314, a search or browse component 316 and a download component 318. The library viewer 308 can display various representations of the user's e-book library. In particular, the library viewer 308 can generate representations of the user's e-books using the records 326. The representations of the user's e-book can be based on the metadata 327, such as the book cover images provided by the publisher for the individual e-books. The library viewer 308 can also display representations for e-books in the user's library that are associated with the user's account, rather than the particular device. Thus, for example, the library representations provided by the library viewer 308 can include e-books that are not locally stored, but are accessible to the user via the network service 120 (see FIG. 1). The library viewer 308 can display representations of the user's e-books in a variety of formats, such as by list, on a virtual bookshelf or bookcase, or other form of graphic display.

The memory management 320 can retrieve pages of the selected e-book from local memory 330, and provide page content 311 to the e-reader component 312. The e-reader component 312 can process input corresponding to, for example, page events 313, in which the page of the e-book is transitioned (e.g., single transitions, multi-transitions and/or chapter transitions). The memory management 320 can process the input and update the page content 311.

The off-state component 314 can display a content screen 317 when the e-reader device 100 is in the off-state. The memory management 320 can select the content screen 317 for the off-state component 314 based on parameters as the e-book that the user is currently reading, or the e-book that the user most frequently reads.

The search or browse component 316 can include interface features for enabling the user to search, browse and/or select e-books from a service, such as provided through network service 120 and e-book store 122 (see FIG. 1). User selection of a particular e-book can trigger download component 318, which in turn communicates a corresponding e-book identifier 319 to service interface 340. The service interface 340 can retrieve the identified e-book, and perform other necessary operations for the user to acquire the right of possession to the e-book. The operations can include identifying a user account 125 (see FIG. 1), and authorizing payment for the identified e-book.

According to some embodiments, the e-reader system 300 can include a content capture component 328. The content capture component 328 includes logic that communicates and receives input from an input interface of the e-reader device 100, such as from a touchscreen or surface of the device. In one implementation, the content capture component 328 can receive one of an image 335 or ink input 337 as input. By way of example, a user of e-reader device 100 can obtain the signature of the author for a particular e-book. As another example, the user can obtain an image and/or signature of the author.

An e-book assignment component 338 can perform operations that include identifying the e-book in local memory 330 that is to be modified or augmented with the content items provided through the content capture component 328. For example, the e-book assignment 338 can determine which e-book the user selected when the interface for receiving an author signature is initiated. The e-book assignment 338 can also retrieve the publisher indicia 339 for the identified e-book. Additionally, the e-book assignment 338 can combine, integrate or otherwise augment the publisher indicia 339 with one or more of this image 335 and/or ink input 337. In one aspect, the alteration made to the publisher indicia (e.g., book cover image) can be permanent, or made permanent subject to user option.

In one aspect, modified indicia 341 are stored with the local memory 330, as part of the record 326 for the corresponding e-book (e.g., the e-book for which an author provided an autograph). The record 326 can have the metadata 327 updated to reflect, for example, the book cover image with the addition or integration of the ink input 337 and/or image 335. Once updated, the library viewer 308 can generate library representations of the user's e-book collection using the updated record 326 for the particular e-book. Thus, for example, an iconic version of the book cover image for the particular e-book that received the ink input 337 (e.g., author autograph) can reflect indicia corresponding to the signature and/or image.

Still further, one embodiment provides that the off-state component 314 can receive content screen 317 that is based on the metadata 327 of a given record 326. When the particular e-book that received the autograph is selected for the off-state (e.g., when the particular e-book is in the state of being read), the content screen 317 can display the modified indicia 341, such as a modified version of the book cover image that includes the ink input 337 and/or image 335.

Some embodiments recognize instances when the user wants to obtain an autograph (e.g., ink input 337) or author's image (image 335), without having possession of a corresponding e-book for which the content items are to be integrated. For example, a user may have an encounter with an author, then seek an e-book of the author after the encounter. The e-book assignment 338 can include processes that obtain a criterion 347 for e-book, based on the received content items. For example, the e-book assignment 338 can implement processes to recognize a name from the ink input 337 and/or a face from the image 335. From the recognition, an author name can be determined that is to be used as criterion 347. The criterion 347 can be communicated to the search/browse component 316, which in turn returns results based on the criterion 347. In variations, the generation of the criterion 347, as well as the subsequent search can be substantially automatic (e.g., user provides triggering input or no input). In still another variation, the e-book that is authored by the person providing, for example, ink input 337 can be identified for the user, and the user can be provided the option to purchase the identified e-book from, for example, the e-book store 122 of the network service 120. Once the e-book is downloaded via the service interface 340, the e-book assignment component 338 can affix the ink input 337 and/or image 335 and store the modified indicia 341 with the local memory 330.

Methodology

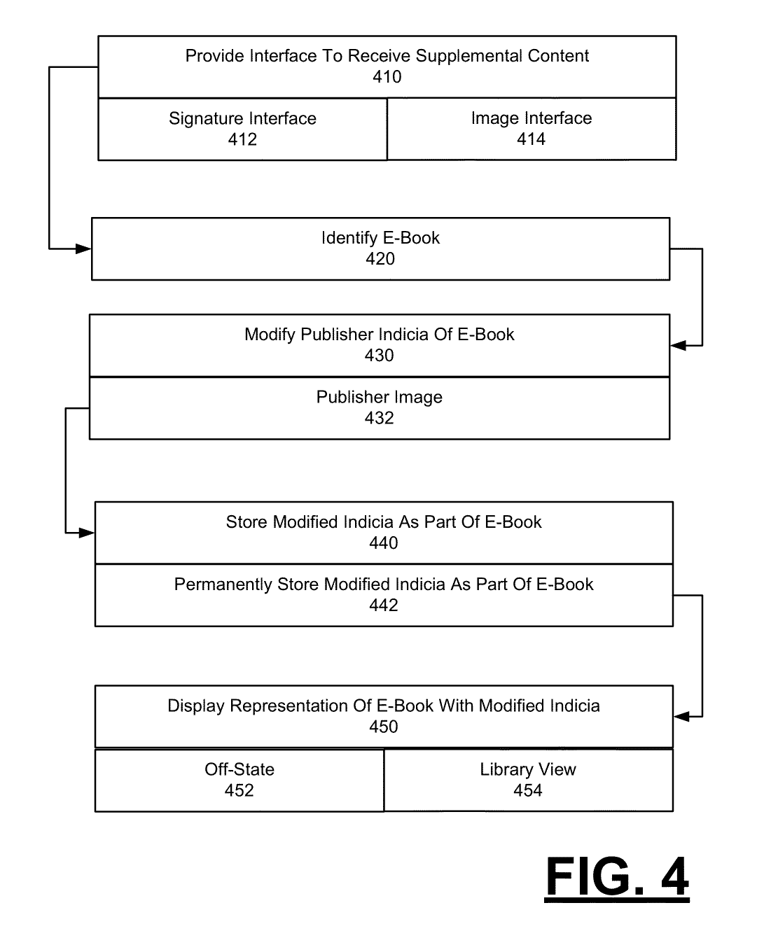

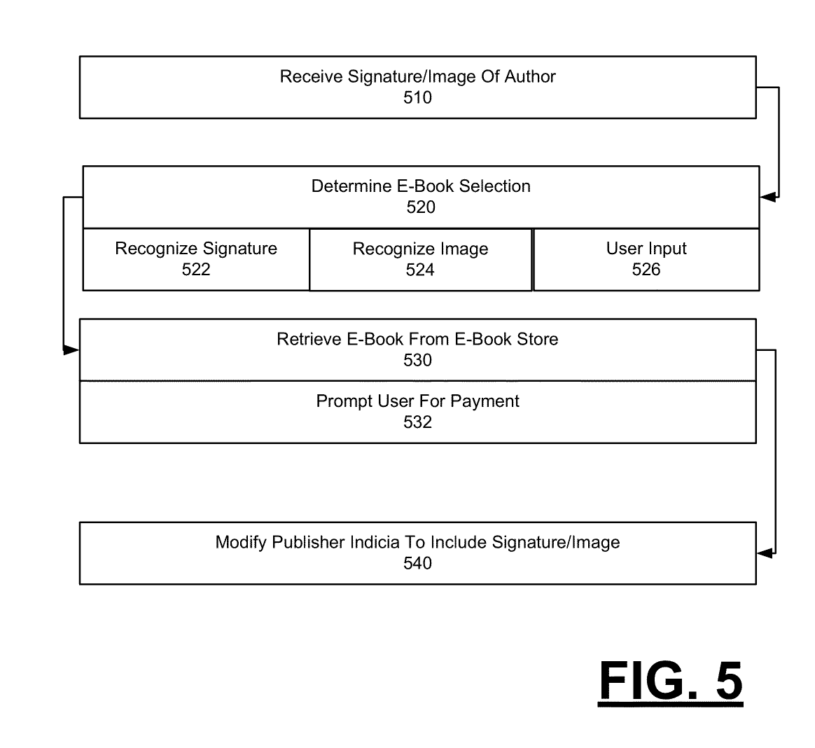

FIG. 4 illustrates a method for capturing and integrating content items with an e-book, according to one or more environment. FIG. 5 illustrates a method for acquiring an e-book based on the obtained signature or image of an author, according to one the more embodiments. In describing examples of FIG. 4 or FIG. 5, reference may be made may be made to elements provided with other figures, including with FIG. 2 or FIG. 3, for purpose of illustrating suitable components for performing a step or sub-step being described.

With reference to FIG. 4, an interface is provided to receive supplemental content items on the e-reader device 100 of the user (410). In particular, the supplemental content items can correspond to content relating to an author of a given e-book. As described with numerous examples herein, such supplemental content items can be integrated into the representation of an e-book within an e-reader device 100, so that the representation of the e-reader device is altered or transformed to reflect the capture of such supplemental content items. In this way, the inclusion of content items such as a signature or image of the author can transform a given e-book into a trophy or personalized copy. According to embodiments described herein, the user can utilize his or her own e-reader device 100 in order to capture the autograph or image of an author. In one implementation, the reader device can provide a signature interface (412). The signature interface can allow for the author to draw (e.g., with “ink” input) or otherwise gesture his signature onto a touch sensitive surface of the e-reader device 100. For example, the author can trace his signature onto a given block of the touchscreen on the e-reader device 100. As an alternative or addition, in image of the author can be captured using a camera on the e-reader device 100 (414). Alternatively, the e-reader device 100 can obtain an image from another source, such as from a network source.

When supplemental content corresponding to the signature or image of an author is received, a corresponding e-book is identified (420). In one implementation, an interface is opened or otherwise associated with an e-book that is resident in the local memory 330 of the e-reader device 100. In variations, such as described with an example of FIG. 5, the supplemental content items are captured as asynchronously or independently of a corresponding e-book. Alternatively, the content capture interface 328 can be opened and correlated to e-book for which a record 326 exist in the memory 330. For example, the record 326 of the archive e-book can be used to initiate the content capture interface from which supplemental content items (e.g., autograph) are obtained.

The identified e-book is modified based on the captured content items (430). In particular, the modification may be made to the metadata 327 associated with the e-book. More specifically, the publishers indicia such as provided by the book cover image, is modified to include the captured signature and/or image (432).

The modified aspects of the e-book can be stored as part of the e-book (440). In particular, the modified indicia (e.g., book cover image) can be stored. In some implementations, the modification can be made permanent (442). For example, the modified book cover image can replace the original book cover image. Alternatively, pixels that comprise a portion of the book cover image can be replaced to include the signature and/or image obtained through the content capture interface 328.

The representation of an e-book can be updated to include a modified publisher's indicia (450). For example, the e-reader device 100 can display representations of e-books using book cover images provided by the publisher. When the e-book receives content items such as ink input 337 and/or image 335, the book cover image can be modified. In particular, the representation of the e-book within the various operating environments of the e-reader device 100 can be altered to reflect the modified book cover image. In one embodiment, the book cover image of the e-book as displayed in, for example, the off-state of the device (452). For example, when the particular e-book is in a state of being read and the device is in the off-state, the content screen 317 can be based on the modified book cover image. As an alternative of variation, the modified book cover image can be displayed in iconic form among lists of books that comprise the user's library (454).

With reference to FIG. 5, the autograph and/or image of an author are received on the e-reader device 100 (510). As described with other examples, the signature and/or image can be obtained by the author directly interacting with the e-reader device 100 of the user. For example, the user can request an author to provide the supplemental content items, then trigger the interface by which the author can provide input through direct interaction with the e-reader device 100. For example, the author can provide the autograph by drawing his finger over a touchscreen of the user's e-reader device 100, to mimic the author's pen-on-paper autograph, as well as to provide additional phrases or ink (personalized well wishes). The author can also pose for an image that can be captured to the camera of the e-reader device 100.

While an example of FIG. 4 provides for the author to provide the supplemental content items in the context of the author's e-book being resident on the user's e-reader device 100, an example of FIG. 5 recognizes a situation in which the e-book is not resident on the e-reader device and not part of the user's account. According to some embodiments, components of the e-reader device 100 can perform recognition on either the autograph (522) or image (524) of the author. The recognition can result in an author identification, such as an author name. In a variation, the user can provide input subsequent or preceding the capture of the supplemental content items (526). The input can identify the author, or provide other information for identifying an e-book written by the individual providing the supplemental content items. For example, the user can identify the name of the book title, rather than the name of the author.

Once an identifier for the author is determined, an e-book of the author can be retrieved from an e-book service (530). For example, the e-book of the author can be retrieved from the e-book store 122 of network service 120. In retrieving the e-book, the user can be prompted for payment, or automatically debited based on the account information and settings of the user (532). In this way, the author can be provided immediate reward for providing an autograph or other form of interaction with a new reader.

Once an e-book is retrieved, the publisher indicia of the retrieved e-book are modified, based on the captured content items provided by the author (540). Thus, for example, the autograph or image of the author can be affixed to a particular e-book, even though the content items are acquired before the e-book becomes resident (e.g., stored in memory 330) on the user's e-reader device 100.

### Examples

FIG. 6 illustrates a content capture interface for use with an e-reader device 100, according to one or more embodiments. In more detail, a content capture interface 610 can be generated on, for example, a display surface of a user's e-reader device 100. Among other aspects, the content capture interface 610 can include components for capturing a signature or image of a person. In an embodiment, the content capture interface 610 can provide the signature block 614 to prompt a person to enter their signature. For example, an author can place their finger on a touch-sensitive display screen or area of the e-reader device 100 in order to draw their autograph in the signature block 614. The input can be captured, and an ink representation of the input can be generated to represent the autograph of the author.

Likewise, the image capture component 612 can be used to capture an image, such as the image of the author. Alternatively, a component 608 can be used to select an image that is already resident on the device. For example, the camera of the e-reader device 100 may have previously captured images, from which the user can make selection, in order to include additional content as modification to the book cover image of a particular e-book.

In one implementation, the content interface 610 can be provided over the book cover image of the selected e-book (e.g., the user can identify the e-book that is to receive the autograph of an individual). The placement of the signature or other content item can thus be identified by the positioning of the content capture interface 610 with respect to a book cover image. Alternatively, the content capture interface 610 can position captured content items (e.g., autograph) on portions of the book cover image by default setting (e.g., bottom center) or intelligently (e.g., where there is space available without obscuring other aspects of the publisher indicia, such as author name or title).

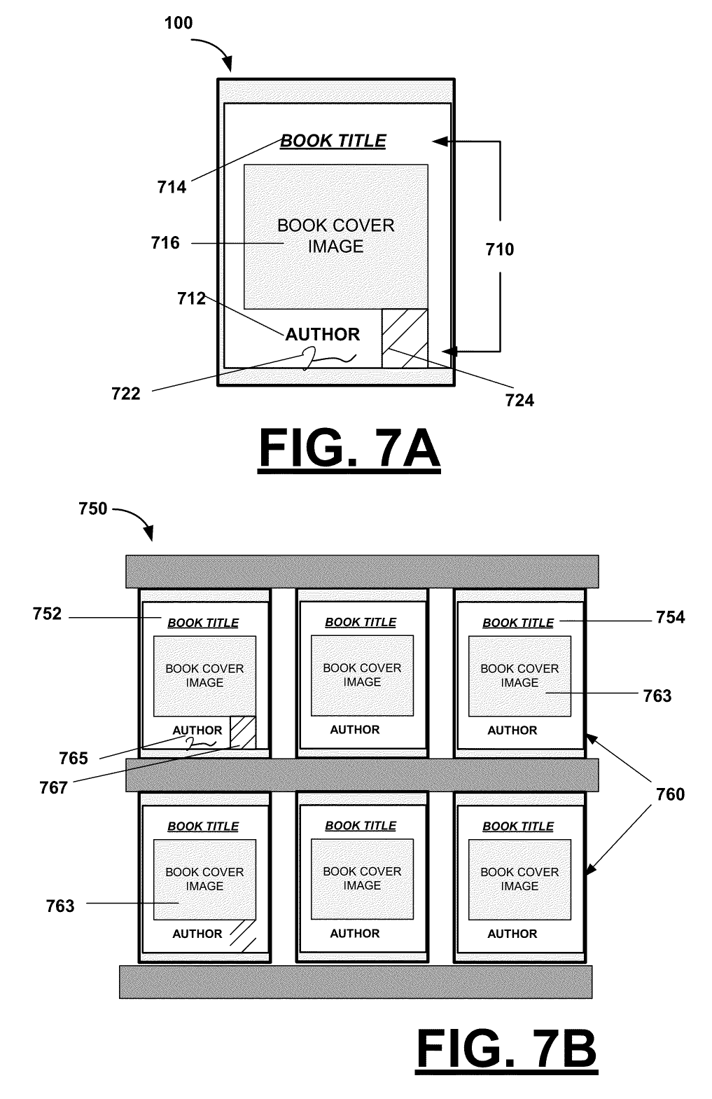

FIG. 7A and FIG. 7B illustrate different operating environments of an e-reader device 100 in which representations of e-books are displayed, according to one or more embodiments. In FIG. 7A, a content screen 710 is provided on the e-reader device 100 when the devices in the off-state. The content screen 710 can identify the publisher's indicia, and more specifically, the book cover image. In the example provided, the publisher indicia can include the book title 714, book cover image 716, and/or additional indicia 712 that identify the author. In the example provided, the captured content item (e.g., ink input 337, image 335) is integrated into the publisher's indicia. In the example provided, an autograph 722 of the author is included along with an image 724 (e.g., image of author and user together).

As mentioned with an example of FIG. 6, the positioning of the supplemental content items can be based on default (e.g., always bottom or bottom center), user selection, author selection (e.g., where author selects to provide signature), and/or programmatic intelligence (e.g., where there is space).

While FIG. 7A is recited in the context of providing the content screen 710 for the e-reader device 100 in the off-state, examples recognize that the content screen can be replicated in other operating environments. For example, the content screen 710 can be replicated when the user elects to view an e-book from the library, and prior to the page contents of the e-book being made available. In such an implementation, the content screen 710 can be enlarged. In variations, the content screen 710 can be reduced or shrunk.

FIG. 7B illustrates a library view of an e-book collection in which at least one e-book includes a modified book cover image. In the example provided, the library view simulates a bookshelf 750 with multiple shelves 760. Each bookshelf 760 can include a representation 762 of a particular e-book in the collection. The representation can include a book cover image 763. The book cover image 763 can be modified to include content items corresponding to the signature 765 or image 767. By way of example, the signature 765 can correspond to the autograph of the author. Still further, the image can correspond to an image selected or taken by the user (e.g., user and author standing together).

Although illustrative embodiments have been described in detail herein with reference to the accompanying drawings, variations to specific embodiments and details are encompassed by this disclosure. It is intended that the scope of embodiments described herein be defined by claims and their equivalents. Furthermore, it is contemplated that a particular feature described, either individually or as part of an embodiment, can be combined with other individually described features, or parts of other embodiments. Thus, absence of describing combinations should not preclude the inventor(s) from claiming rights to such combinations.

What is claimed is:

1. A method for providing an e-book, the method being implemented by one or more processors and comprising:
capturing one or more content items on a computing device associating the one or more content items with an e-book;
identifying a publisher's indicia for displaying a representation of the e-book;
altering the publisher's indicia to include content corresponding to the one or more content items; and
providing a representation of the e-book that is based on the altered publisher's indicia, the representation being selectable or interactive in order to access a content portion of the e-book.

2. The method of claim 1, wherein altering the publisher's indicia includes permanently altering the e-book so that the publisher's indicia includes the content.

3. The method of claim 1, wherein providing the representation includes displaying an icon that is based on the altered publisher's indicia.

4. The method of claim 3, wherein displaying the icon includes displaying a book cover image in an altered form.

5. The method of claim 3, further comprising displaying the icon as part of an e-book library.

6. The method of claim 1, wherein capturing one or more content items includes detecting ink input provided on an interface of the computing device, and wherein altering the publisher's indicia includes incorporating at least a portion of the ink input into the publisher's indicia.

7. The method of claim 1, wherein capturing one or more content items includes receiving an image, and wherein altering the publisher's indicia includes incorporating the image into a book cover image.

8. The method of claim 1, wherein altering the publisher's indicia includes replacing at least a portion of the publisher's indicia with the content corresponding to the one or more content items.

9. The method of claim 1, wherein altering the publisher's indicia includes altering a book cover image of the e-book, and wherein the method further comprises displaying the altered book cover image in iconic form as part of a user's e-book library.

10. The method of claim 1, wherein altering the publisher's indicia includes altering a book cover image of the e-book, and wherein the method further comprises displaying the altered book cover image when the computing device is in an off-state.

11. The method of claim 1, wherein:
capturing one or more content items includes capturing a signature of an author;
and wherein the method further comprises:
identifying one or more book titles of the author, the e-book corresponding to one of the one or more book titles.

12. The method of claim 11, further comprising downloading the e-book corresponding to the one or more book titles, and then performing each of (i) identifying the publisher's indicia for displaying the representation of the e-book; and (ii) altering the publisher's indicia to include content corresponding to the one or more content items.

13. A computing device comprising:
a memory;
one or more input mechanisms;
a display;
a processor, the processor operating to:
capture one or more content items that are provided through operation of the input mechanism;
associate the one or more content items with an e-book;
identify a publisher's indicia for displaying a representation of the e-book;
alter the publisher's indicia to include content corresponding to the one or more content items;
store the altered publisher's indicia in the memory; and
provide, on the display, a representation of the e-book that is based on the altered publisher's indicia, the representation being selectable in order to access a content portion of the e-book.

14. The computing device of claim 13, wherein the processor provides the representation by displaying an icon that is based on the altered publisher's indicia.

15. The computing device of claim 14, wherein icon includes a book cover image that is altered to include the content that is based on the content items.

16. The computing device of claim 14, wherein the processor displays the icon as part of an e-book library.

17. The computing device of claim 13, wherein the processor captures one or more content items by detecting an ink input provided on an interface of the computing device, and wherein the processor afters the publisher's indicia by incorporating the ink input into the publisher's indicia.

18. The computing device of claim 13, wherein the processor captures the one or more content items by receiving an image, and wherein the processor alters the publisher's indicia by incorporating the image onto a book cover image.

19. The computing device of claim 13, wherein the processor afters the publisher's indicia by replacing at least a portion of the publisher's indicia with the content corresponding to the one or more content items.

20. A computer-readable medium including instructions for providing an e-book, the instructions being executable by one or more processors to cause the one or more processors to perform operations that include:
capturing one or more content items on a computing device associating the one or more content items with an e-book;
identifying a publisher's indicia for displaying a representation of the e-book;
altering the publisher's indicia to include content corresponding to the one or more content items; and
providing a representation of the e-book that is based on the altered publisher's indicia, the representation being selectable or interactive in order to access a content portion of the e-book.
